(19) United States
(12) Patent Application Publication
(10) Pub. No.: US 2010/0271031 A1
(43) Pub. Date: Oct. 28, 2010

(54) Standoff-Independent Resistivity Sensor System

(75) Inventors: Jens Behnsen, Hannover (DE); Hans-Juergen Faber, Neustadt (DE); Uwe Schrader, Celle (DE); Volker Krueger, Celle (DE)

Correspondence Address: Mossman, Kumar and Tyler, PC, P.O. Box 421239, Houston, TX, 77242, US

(73) Assignee: BAKER HUGHES INCORPORATED, Houston, TX (US)

(21) Appl. No.: 12/762,634

(22) Filed: Apr. 19, 2010

Related U.S. Application Data
(60) Provisional application No. 61/172,942, filed on Apr. 27, 2009.

(51) Int. Cl. G01V 3/02

(52) U.S. Cl. 324/355

(57) ABSTRACT

A contact subassembly on a downhole carrier is moved by torsion rod, rotation of which moves the contact assembly to the proximity of the borehole wall. Rotation of the torsion rod may be accomplished by a hydraulically powered piston-lever arrangement. The rotation of the torsion bar may be used to estimate the borehole size. The contact assembly may be provided with resistivity sensors, acoustic sensor for making VSP measurements while drilling, and a port for sampling a formation fluid.

### CROSS-REFERENCES TO RELATED APPLICATIONS

This applications claims priority from U.S. Provisional Patent Application Ser. No. 61/172,942 filed on Apr. 27, 2009.

### BACKGROUND OF THE DISCLOSURE

1. Field of the Disclosure

The present disclosure relates to well logging. In particular, the present disclosure is an apparatus and method for determining the property of subsurface formations using contact devices.

2. Background of the Art

The disclosure is first described with reference to the use of contact devices in resistivity measurements. In conventional galvanic resistivity measurement tools using a focusing technique, a guard electrode emits current in order to lead the current beam of a measurement electrode deeper into a conductive material. The resistivity of the material is determined by means of measurement electrode's voltage and current registration. The driving potential on guard and measurement electrode must be exactly the same to avoid disturbances of the ideal electrical field, which makes sure that the focusing effect takes place. Higher driving potential differences may lead to currents from guard to measurement electrode or vice versa passing the borehole fluid around the tool, which would completely destroy the focusing effect and lead to high measurement errors if not considered. In general, the focusing effect will lead to an electrical current with a higher penetration depth compared to that without focusing.

One of the problems in making resistivity measurements while drilling (MWD) is that the drilled borehole has a larger diameter than the sensor module. The difference in diameter results in different standoffs of the sensor electrodes from the borehole wall. In water-based mud, the varying standoff results in current flows that are not radially directed from the sensor electrodes to the wall, resulting in smearing of the resistivity image. In oil-based mud, the varying standoff result in different gap impedances in the flow of electric current from the electrode to the formation, so that the value of the current is not indicative of the formation resistivity near the electrode.

Prior art methods have attempted to address this problem with varying degrees of success by using focusing and guard electrodes (adding to the complexity of the hardware) and by processing methods. The present disclosure provides a simple hardware solution to the problem of variable standoff.

### SUMMARY OF THE DISCLOSURE

One embodiment of the disclosure is an apparatus configured to evaluate an earth formation. The apparatus includes: a carrier configured to be conveyed in a borehole; a torsion bar coupled to the carrier; a contact assembly coupled to the torsion bar; and an actuator associated with the torsion bar, the actuator configured to provide a torsion force to the torsion bar, the torsion force being used to maintain a contact assembly in a position proximate to a wall of the borehole.

Another embodiment of the disclosure is a method of evaluating an earth formation. The method includes: conveying a carrier including a torsion bar into a borehole; and using an actuator associated with the torsion bar to provide a torsion force that maintains a contact assembly on the carrier proximate to a wall of the borehole.

### BRIEF DESCRIPTION OF THE FIGURES

The novel features that are believed to be characteristic of the disclosure, both as to organization and methods of operation, together with the objects and advantages thereof, will be better understood from the following detailed description and the drawings wherein the disclosure is illustrated by way of example for the purpose of illustration and description only and are not intended as a definition of the limits of the disclosure:

FIG. 1 is a schematic illustration of a drilling system;

FIG. 2 (prior art) is an exemplary configuration of the various components of a resistivity measuring sensor sub;

FIG. 3 is an equivalent circuit for resistivity devices having electrodes;

FIG. 4 shows a first view of a resistivity sensor sub according to the present disclosure; and

FIG. 5 is a second view of the resistivity sensor sub according to the present disclosure.

### DETAILED DESCRIPTION OF THE DISCLOSURE

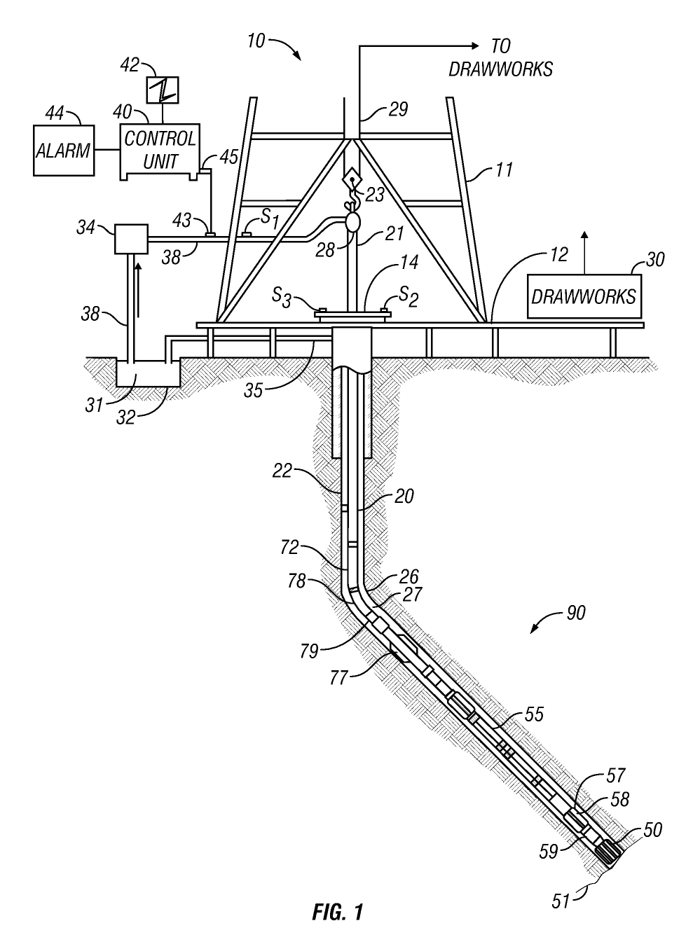

FIG. 1 shows a schematic diagram of a drilling system 10 with a drillstring 20 carrying a drilling assembly 90 (also referred to as the bottom hole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel, 28 and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger 36, fluid line 28 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ preferably placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the disclosure, the drill bit 50 is rotated by only rotating the drill pipe 22. In another embodiment of the disclosure, a downhole motor 55 (mud motor) is disposed in the drilling assembly 90 to rotate the drill bit 50 and the drill pipe 22 is rotated usually to supplement the rotational power, if required, and to effect changes in the drilling direction.

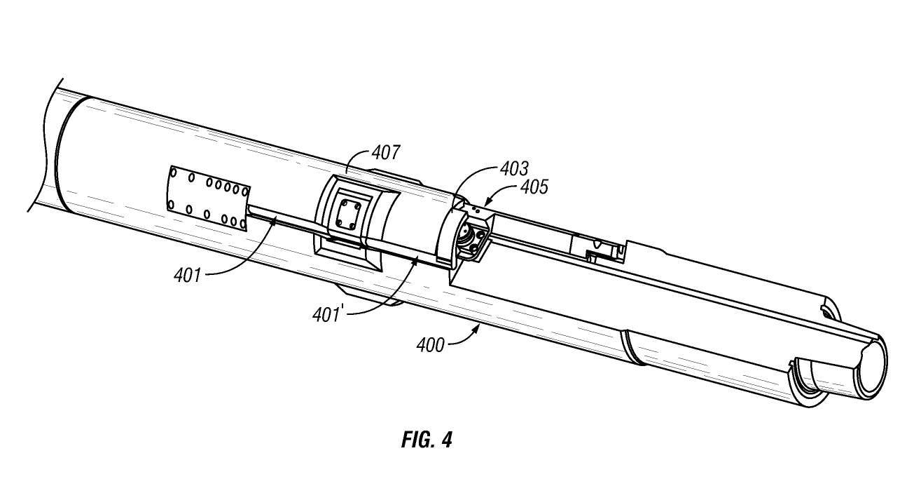

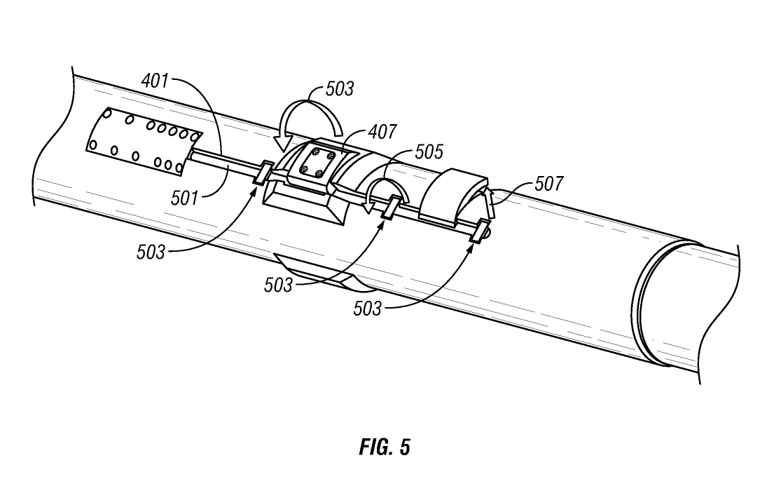

In the embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly. A novel aspect of the apparatus shown in FIG. 1 is a sub assembly described below with reference to FIGS. 4 and 5.

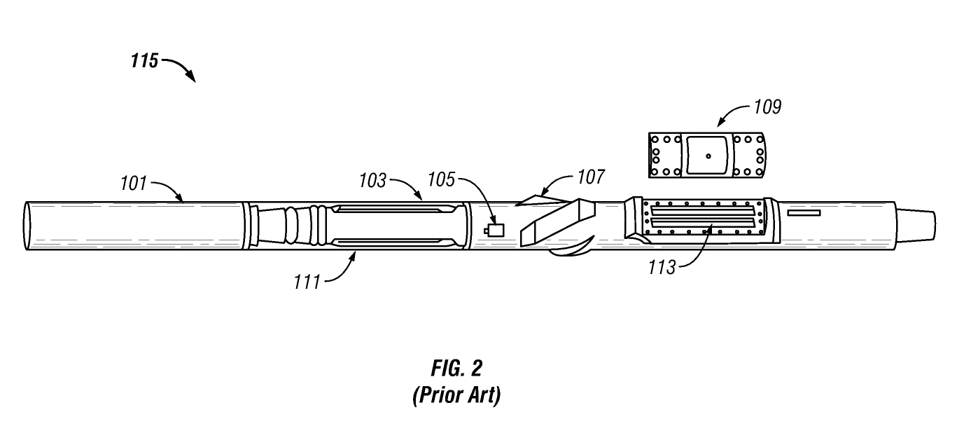

Turning now to FIG. 2, an exemplary configuration of the various components of a resistivity measuring sensor sub is shown. At the upper end, a modular cross-over sub 101 is provided. The power and processing electronics are indicated by 103. The sub is provided with a stabilizer 107 and a data dump port may be provided at 105. A resistivity sensor is provided at 109 with the sensor and measuring electronics at 113. The sensor 109 is provided with a plurality of current electrodes (discussed below). Modular connections 115 are provided at both ends of the sub that enable the sub to be part of the bottom hole drilling assembly. An orientation sensor 111 is provided for measuring the toolface angle of the sensor assembly during continued rotation. Different types of orientation sensors may be used, including magnetometers, accelerometers, or gyroscopes. Use of such devices for determination of the toolface angle is known in the art and is not discussed further herein.

The stabilizer shown at 107 serves several functions. Like conventional stabilizers, one function is to reduce oscillations and vibrations of the sensor assembly. However, in the context of the present disclosure, it also serves another important function, viz, centralizing the portion of the bottomhole assembly (BHA) including a sensor assembly, and also maintaining the sensors with a specified standoff from the borehole wall. This is not visible in FIG. 2, but the outer diameter of the stabilizer is greater than the outer diameter of the portion of the BHA including the resistivity sensor. As a result of this difference in diameter, the resistivity sensor is maintained with a standoff from the borehole wall during continued rotation of the drillstring.

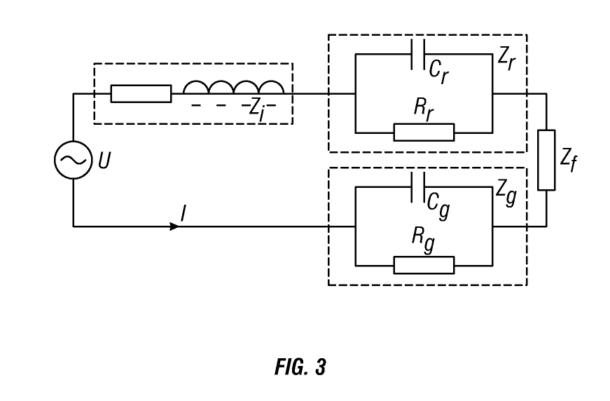

The equivalent circuit for the flow of current through a sensor electrode is shown in FIG. 3. The power source for the sensor is denoted by U and the impedance of the gap between the sensor electrode and the borehole wall Z_{g} includes a resistive component R_{g} and a capacitive component C_{g}. The formation impedance is denoted by Z_{f}. For the sake of completeness, the impedance Zᵣ at a return electrode at a remote location (not showan), made up of a resistive component Rᵣ and a capacitive component Cᵣ, is shown but usually ignored as being small. Similarly, an inductive impedance Zᵢ is also ignored. The important point to note is that Z_{g} changes with standoff, and can be large enough in comparison with Z_{f} to affect the flow of current through the electrode. Hence the estimated formation resistivity will be in error.

To avoid the problems associated with variable standoff, a novel subassembly is used. This is illustrated by 400 in FIG. 4. For reasons that will become apparent later, the sub may be referred to as a carrier. The sub includes a hydraulic unit 405. The hydraulic unit 405 includes piston (not shown in FIG. 4) that pushes a lever 403 that in turn rotates a torsion bar 401′. The contact assembly 407 is positioned between the torsion bar 401′ and another torsion bar 401. Rotation of the torsion bar 401′ moves the contact assembly 407 outward so it can engage the borehole wall. For the purposes of the present disclosure, the torsion bars may also be referred to as springs. In one embodiment of the disclosure, the contact assembly includes a sensor pad (as shown in FIG. 4) that is provided with electrodes. Other embodiments of the contact assembly are discussed further below.

As shown in FIG. 5, the torsion bar 401 is provided with an internal cable bore 501 that provides a conduit for electrical leads from the contact assembly 407. Movement of the contact assembly 407 is indicated by 503. As can be seen, the contact assembly may be moved proximate to the borehole wall. For the purposes of the present disclosure, the term “proximate to the borehole wall” is intended to mean “in contact with the borehole wall or close to the borehole wall.” The term “close to” is to be interpreted in the context that the contact assembly is used. For example, in one embodiment of the disclosure, the contact assembly is provided with a sensor pad having electrodes for making resistivity measurements. In this situation, the term “close” is intended to mean “less than 0.25 inches (5 mm)”. In another embodiment of the disclosure, the contact assembly is provided with a seal and a plug for drawing a sample of a formation fluid. In this case, the term “close” means that the seal and plug of the contact assembly are in actual physical contact with the borehole wall. In another embodiment of the disclosure, the contact assembly is provided with a geophone having up to three components that make actual physical contact with the borehole wall for making (Vertical Seismic Profiling) VSP while drilling measurements.

The torsion bar 401 may be provided with bearings 503. The rotation of the torsion bar 401 is indicated by the arrow 505 while the motion of the actuator is indicated by 507.

When the contact assembly is provided with a sensor pad having sensor, the pad can follow the contour of the borehole The force on the contact assembly 407 against the borehole will be proportional to the displacement of the lever 403 which, in turn, is proportional to the hydraulic pressure in the hydraulic unit 405.

With such a configuration, it is possible to have the sensor pad with a very small offset from the borehole wall. The currents through the electrodes are then indicative of the resistivity property of the earth formation as the gap impedance is very small. A resistivity image of the borehole wall can be produced from the currents in the electrodes using prior art methods and recorded on a tangible medium. To protect the sensor pad 407 from wear, it may be provided with a hardfacing such as polycrystalline diamond (PCD).

The displacement of the sensor pad 407 can be measured by measuring the torsion angle of the torsion bar 401 indicated by the displacement of the lever 403 or the piston. For the purposes of the present disclosure, the displacement of the lever 403 and of the piston are considered to be equivalent. The displacement of the contact assembly 407 thus provides a caliper measurement of the borehole. Assuming that the side of the sub 400 opposite to the sensor pad 407 is also in contact with the borehole wall, a continuous measurement of borehole diameter is obtained. When combined with the orientation measurement from the orientation sensor 111, it is possible to obtain a continuous image of the size of the borehole in addition to the resistivity image obtained from the resistivity measurements.

With the apparatus and method of the present disclosure, a resistivity image can be obtained in a MWD environment using orientation measurements by a suitable orientation sensor 111 such as a magnetometer. Methods of producing such images are discussed, for example, in U.S. Pat. No. 6,173,793 to Thompson et al, having the same assignee as the present disclosure and the contents of which are incorporated herein by reference. The method of the present disclosure may also be used to produce a resistivity image of an earth formation using a plurality of pads conveyed on a wireline, each of the pads containing a plurality of measure electrodes, guard electrodes and bridge-coupling circuits.

The processing of the data may be done by a downhole processor to give corrected measurements substantially in real time. Alternatively, the measurements could be recorded downhole, retrieved when the drillstring is tripped, and processed using a surface processor. Implicit in the control and processing of the data is the use of a computer program on a suitable machine readable medium that enables the processor to perform the control and processing. The machine readable medium may include ROMs, EPROMs, EEPROMs, Flash Memories and Optical disks.

What is claimed is:

1. An apparatus configured to evaluate an earth formation, the apparatus comprising:
a carrier configured to be conveyed in a borehole;
a torsion bar coupled to the carrier;
a contact assembly coupled to the torsion bar; and
an actuator associated with the torsion bar, the actuator configured to provide a torsion force to the torsion bar, the torsion force being used to maintain a contact assembly in a position proximate to a wall of the borehole.

2. The apparatus of claim 1 wherein the contact assembly further comprises a sensor assembly configured to make a measurement of a property of the earth formation.

3. The apparatus of claim 2 wherein the sensor assembly further comprises a sensor pad configured to be proximate to the wall of the borehole.

4. The apparatus of claim 2 wherein the sensor assembly further comprises a plurality of electrodes.

5. The apparatus of claim 2 wherein the sensor assembly further comprises a sensor configured to provide an output signal indicative of at least one of: (i) a resistivity property of the earth formation, (ii) an optical property of the earth formation, (iii) a seismic property of the earth formation.

6. The apparatus of claim 2 wherein the contact assembly further comprises a seal and a port for admitting a fluid from the earth formation.

7. The apparatus of claim 4 further comprising:
a power source configured to convey an electrical current into the formation through the plurality of electrodes; and
at least one processor configured to provide an image of a resistivity property of the earth formation using the electrical current in the plurality of electrodes.

8. The apparatus of claim 1 wherein the actuator further comprises a lever arm configured to be moved by a hydraulically operated piston.

9. The apparatus of claim 1 further comprising an orientation sensor configured to provide an orientation of the carrier during rotation thereof.

10. The apparatus of claim 9 further comprising a processor configured to use a signal indicative of the rotational motion and a position of the actuator to provide an image of a size of the borehole.

11. The apparatus of claim 3 further comprising a facing of polycrystalline diamond on the sensor pad configured to reduce abrasion of the sensor pad.

12. The apparatus of claim 1 wherein the at least one torsion rod includes a conduit for an electrical lead from the sensor pad.

13. A method of evaluating an earth formation, the method comprising:
conveying a carrier including a torsion bar into a borehole;
using an actuator associated with the torsion bar to provide a torsion force that maintains a contact assembly on the carrier proximate to a wall of the borehole.

14. The method of claim 13 further comprising using a sensor assembly in the contact assembly to make a measurement of a property of the earth formation.

15. The method of claim 14 further comprising using a sensor pad on the sensor assembly to be proximate to the wall of the borehole.

16. The method of claim 14 further comprising using a plurality of electrodes o the sensor pad to provide a signal indicative of a resistivity property of the earth formation.

17. The method of claim 14 further comprising using a sensor on the sensor pad to provide an output signal indicative of at least one of: (i) a resistivity property of the earth formation, (ii) an optical property of the earth formation, and (iii) a seismic property of the earth formation.

18. The method of claim 14 further comprising using a seal and a port on the contact assembly for admitting a fluid from the earth formation.

19. The method of claim 14 wherein providing the torsional force further comprises providing rotational motion to the at least one torsion rod using a lever operated by a hydraulically actuated piston.

20. The method of claim 14 further comprising measuring an orientation of the carrier during rotation thereof and using the measured orientation for providing the image of a property of the formation.

21. The method of claim 20 further comprising using a signal indicative of the rotational motion and a motion of the actuator to provide an image of a size of the borehole wall.

22. The method of claim 14 further comprising conveying an electrical lead from the contact assembly through a conduit on the at least one torsion rod.
